(19) United States
(12) Patent Application Publication
(10) Pub. No.: US 2022/0298077 A1
(43) Pub. Date: Sep. 22, 2022

(54) FLOOR PATCHING COMPOSITION

(71) Applicants: DENKA COMPANY LIMITED, Tokyo (JP); DENKA CONSTRUCTION SOLUTIONS MALAYSIA SDN. BHD., Shah Alam, Selangor Darul Ehsan (MY)

(72) Inventor: Takayuki HIGUCHI, Shah Alam (MY)

(73) Assignee: DENKA COMPANY LIMITED, Tokyo (JP)

(21) Appl. No.: 17/616,728

(22) PCT Filed: Jul. 8, 2020
(86) PCT No.: PCT/MY2020/050049

§ 371 Date: Dec. 6, 2021

(30) Foreign Application Priority Data
Jul. 12, 2019 (MY) PI2019004052

(51) Int. Cl. C04B 28/16; C04B 18/14; C04B 14/06; C04B 14/28; C04B 24/26; E04G 23/02; E01C 11/00

(52) U.S. Cl. CPC C04B 28/16; C04B 18/141; C04B 14/06; C04B 14/28; C04B 24/2635; C04B 24/2676; C04B 24/2641; E04G 23/0203; E01C 11/005; C04B 2111/72

(57) ABSTRACT

A floor patching composition, including: 100 parts of a dry mortar composition including: 9 to 15 parts of quick-setting cement, and 85 to 94 parts of a sole fine aggregate or a combination of two or more fine aggregates, wherein the sole fine aggregate or the combination has an average true density of 2.8 to 4.0 g/cm³ and a maximum particle size of 1.2 mm or less; 3 to 18 parts of polymer emulsion solid content having a glass transition temperature (Tg) of equal to or higher than −20° C. and equal to or less than 10° C.; and 6 to 18 parts of water.

### TECHNICAL FIELD

The present invention generally relates to a floor patching composition in the field of civil engineering and construction.

### BACKGROUND ART

Floors in facilities or warehouses are often damaged by loading force, e.g., wheeling heavy vehicles such as forklifts and trucks, or putting or stacking cargoes thereon. Such damages have been repaired using mortar based on epoxy resins. Patent Documents 1 and 2 also disclose some conventional polymer cement mortar or compositions for forming pavement surfaces, comprising a polymer emulsion, cement, and a fine aggregate.

### CITATION LIST

### Patent Literature

Patent Document 1: Japanese Patent Application Laid-open Publication No. 2013-234489
Patent Document 2: Japanese Patent Application Laid-open Publication No. 2016-102318

### SUMMARY OF INVENTION

### Technical Problem

The conventional epoxy resin-based materials have certain drawbacks that the materials are expensive and impossible to apply on a wet surface. Although the conventional cement-based compositions of Patent Documents 1 and 2 may work on a wetted place, the conventional compositions take a long time to set, and is difficult to allow early access to the repaired area since it causes damages such as cracks thereon.

### Solution to Problem

The present inventor has studied the problems above, and developed and completed the present invention. An embodiment of the present invention can provide the following aspects.

Aspect 1: A floor patching composition, comprising:
100 parts of a dry mortar composition including:
   9 to 15 parts of quick-setting cement, and
   85 to 94 parts of a sole fine aggregate or a combination of two or more fine aggregates, wherein the sole fine aggregate or the combination has an average true density of 2.8 to 4.0 g/cm³ and a maximum particle size of 1.2 mm or less;
3 to 18 parts of polymer emulsion solid content having a glass transition temperature (Tg) of equal to or higher than −20° C. and equal to or less than 10° C.; and
6 to 18 parts of water.

Aspect 2: The composition according to aspect 1, wherein the quick-setting cement comprises:
50 to 80 parts of cement; and
20 to 50 parts of a rapid hardening agent,
wherein the rapid hardening agent comprises an amorphous calcium aluminosilicate compound in which a glass content is 50% or more, and gypsum.

Aspect 3: The composition according to aspect 1 or 2, wherein the fine aggregate comprises at least a first fine aggregate and a second fine aggregate,
wherein the second fine aggregate has a maximum particle size larger than that of the first fine aggregate, and
wherein the first fine aggregate has an average true density different than that of the second fine aggregate.

Aspect 4: The composition according to aspect 3,
wherein the maximum particle size of the first fine aggregate is less than 0.6 mm, and
wherein the maximum particle size of the second fine aggregate is equal to or greater than 0.6 mm.

Aspect 5: A method for patching a floor, the method comprising the steps of:
providing the composition according to any one of aspect 1 to 4; and
applying the composition onto a floor.

### Advantageous Effects of Invention

An embodiment of the present invention provides a floor patching composition which has a quick-setting property and allows early access to the repaired area compared to the conventional compositions. The present composition can apply onto a floor to provide a durable repaired area with reducing or eliminating cracking and spalling or scaling.

### DESCRIPTION OF EMBODIMENTS

Although embodiments of the present invention will be explained in detail, the present invention is not limited to the embodiments. In the present specification, the units “part” and “percentage (%)” are given on a mass basis unless otherwise defined. In the present specification, a numerical range includes the upper and lower limits unless otherwise defined.

An embodiment of the present invention provides a floor patching composition comprising a dry mortar composition, polymer emulsion (solid content), and water. In the art, floor patching compositions aim to apply onto an area in a floor to be repaired as a relatively thin form, and are clearly different from grouting materials. The term “dry mortar” means a powder to be mixed with water to prepare a mortar, as known in the art. In the embodiment, the dry mortar composition includes quick-setting cement and a fine aggregate.

The quick-setting cement used in an embodiment of the present invention may preferably be cement that produces a large amount of ettringite, 3CaO.Al₂O₃.3CaSO₄.32H₂O. The quick-setting cement may preferably contain, for instance, cement and a rapid hardening agent. The cement may preferably be an ordinary (normal) cement.

The rapid hardening agent may preferably include an amorphous calcium aluminosilicate compound and gypsum. The calcium aluminosilicate compound is almost composed of CaO, Al₂O₃, and SiO₂, and the molar ratio of CaO/Al₂O₃ is in the range of 2.3 to 1.5. The content of SiO₂ may preferably be 0.5 to 20%, more preferably 1 to 15%. These raw materials generally contain impurities such as MgO, Fe₂O₃, TiO₂, K₂O, Na₂O, and V, but they offer no practical problem in the range of 10% or less. The calcium aluminosilicate compound may preferably contain a large amount of amorphous calcium aluminosilicate to maintain fluidity and develop strength. The glass content may preferably be 50% or more. The glass content can be measured by, for instance, powder X-ray diffractometry using a constant amount of reference material to quantify the ratio of crystalline and amorphous substances.

The gypsum may include, but not limited to, calcium sulfate anhydrite, calcium sulfate hemihydrate, and sulfate dihydrate. The calcium sulfate anhydrate may be preferred to maintain fluidity and develop strength.

The amorphous calcium aluminosilicate compound and the gypsum may preferably have the mean grain size of 1 to 20 microns, more preferably 3 to 10 microns to maintain fluidity and develop strength.

The ratio of the amorphous calcium aluminosilicate compound and gypsum in the rapid hardening agent may vary depending on raw materials such as cement. For instance, 100 parts of the rapid hardening agent may contain 40 to 60 parts of the calcium aluminosilicate compound and 40 to 60 parts of gypsum to develop strength and improve durability.

The ratio of the cement and the rapid hardening agent in the quick-setting cement may vary depending on the kind of the agent. For instance, 100 parts of the quick-setting cement may contain 50 to 80 parts of the cement and 20 to 50 parts, more preferably 30 to 40 parts of the rapid hardening agent. If the amount of the rapid hardening agent is 20 parts or more, the repaired area is unlikely to crack even when one allows early access to the repaired area. If the amount of the rapid hardening agent is 50 parts or less, the setting time is preferred to provide good workability.

The fine aggregate used in an embodiment of the present invention may preferably have the average true density of 2.8 to 4.0 g/cm³ and the maximum particle size of 1.2 mm or less, considering workability and durability. The fine aggregate may be a sole material, but more preferably the combination of two or more different fine aggregates. In particular, the fine aggregate may be the combination of one or more heavy fine aggregate(s) and one or more other fine aggregate(s) to cancel their defects and obtain their advantages. The true density of a fine aggregate can be measured by the method according to JIS A1109:2006.

The heavy fine aggregate may include copper slag, ferronickel slag, ferrochrome slag, steelmaking slag, iron oxide powder, barite, and titanium slag. The heavy fine aggregate may preferably have the true density of 3.0 g/cm³ or more. If the fine aggregate contains one or more heavy fine aggregate(s), the resulted composition may have good flowability and high initial strength.

The fine aggregate other than the heavy fine aggregate (hereinafter, referred to as “relatively light fine aggregate”) may include ordinary fine aggregates and light fine aggregates. The ordinary fine aggregate may include sand and gravel such as silica sand and limestone sand (lime sand). The light fine aggregate may include sintered perlite, fly ash balloons, and shirasu balloons. The relatively light fine aggregate may preferably have the true density of less than 3.0 g/cm³. If the fine aggregate contains one or more relatively light fine aggregate(s), the resulted composition may have good flowability and resistance against segregation. The relatively light fine aggregate may preferably comprise silica sand or limestone sand having the true density of 2.5 g/cm³ or more.

In the case that the fine aggregate includes the combination of two or more aggregates, the mixing ratio is not limited as long as the average true density and the maximum particle size fall within the ranges above. In a preferred embodiment, the fine aggregate may contain a heavy aggregate and a relatively light aggregate in the mass ratio of 1:4 to 4:1, more preferably 1:2 to 2:1, e.g., 1:1. In a preferred aspect, the two or more different aggregates may have different maximum particle sizes.

In contrast, if the fine aggregate has the average true density or the maximum particle size outside the ranges above, the resulted composition provides poor durability for the repaired area due to sedimentation or segregation; or has a poor flow and bad workability.

In a preferred embodiment, the fine aggregate may include the combination of the first fine aggregate having the maximum particle size of less than 0.6 mm and the second fine aggregate having the maximum particle size of 0.6 to 1.2 mm such that the total aggregate has the average true density of 2.8 to 4.0 g/cm³. An example of a more preferred aspect may include the combination of ferronickel slag (heavy aggregate) having the average true density of 3.20 g/cm³ and the maximum particle size of less than 0.6 mm and silica sand (relatively light aggregate) having the average true density of 2.65 g/cm³ and the maximum particle size of 0.6 to 1.2 mm such that the mixture has the average true density of 2.8 to 4.0 g/cm³. The preferred aspect can provide a floor patching composition which has both good workability and excellent durability. In an embodiment, the composition may not contain any aggregates other than the fine aggregate above. In another embodiment for applying thickly onto a deep hollowed portion to be repaired, the floor patching composition may further include a large aggregate other than the fine aggregate(s) above. The other large aggregate may have the maximum particle size in the range of more than 1.2 mm to 7 mm.

Without wishing to be bound by any theory, it is assumed that a dry mortar composition containing two or more different fine aggregates would let the aggregates have different fluid dynamics when mixed with the given medium, i.e., the given polymer emulsion and water having the given viscosity. The different aggregates would cancel their defects for each other. The resulted composition can thus exert the excellent synergistic effect.

The polymer emulsion used in an embodiment of the present invention may preferably have the glass transition temperature (Tg) of −20 degrees C. or more and 10 degrees C. or less. If the Tg is less than −20 degrees C., the resulted composition has poor adhesive strength. If the Tg is more than 10 degrees C., the repaired area occurs defects such as cracks and spalling or scaling when one accesses to the area early.

The polymer emulsion may include, for instance, acrylic, acrylic styrene, vinyl acetate, butadiene, and chloroprene-based emulsions. The amount of polymer emulsion in the floor patching composition may preferably be 3 to 18 parts, as solid content, on the basis of 100 parts of the dry mortar composition. If the polymer emulsion is less than 3 parts, the resulted composition has poor flexibility. If the polymer emulsion is more than 18 parts, the resulted composition would reduce strength.

A floor patching composition according to an embodiment of the present invention may include water such as tap water. The amount of water may preferably be 6 to 18 parts with respect to 100 parts of the dry mortar composition. Note that, if the polymer emulsion contains some water, the amount should be added to the water content.

The present composition may further contain, as long as the composition can substantially achieve the goal of the present invention, one or more of water reducing agents or dispersion agents; high-performance water reducing agents; AE water reducing agents; high-performance AE water reducing agents; fluidizing agents; defoaming agents; thickeners; corrosion inhibitors; non-freezing agents; shrinkage reducing agents; setting regulators; retarders; fibers; fly ash; silica fume; clay minerals such as bentonite and zeolite; and anion exchangers such as hydrotalcite.

### EXAMPLES

The present invention is further illustrated by the following examples.

The following materials were mixed in the ratio shown in Table 1 below to prepare respective floor patching compositions. The amount of retarder (not shown in Table 1) was 5% of the rapid hardening agent and added in outer percentage. Every composition was subjected to evaluations of flow, segregation, setting time, adhesive strength, and resistance for early access as follows.

Materials

Cement: ordinary cement, a commercial product.

Rapid hardening agent: 50 parts of calcium aluminosilicate (the molar ratio of CaO/Al₂O₃=1.9; SiO₂ content=3%; glass content=100%; the mean grain size=4 microns) and 50 parts of calcium sulfate anhydrate (the mean grain size=4 microns).

Retarder: D200 Setter, manufactured by Denka

Fine aggregate No. 1-1: ferronickel slag (FN) aggregate, true density=3.20 g/cm³, maximum particle size=under 0.6 mm

Fine aggregate No. 1-2: ferronickel slag (FN) aggregate, true density=3.20 g/cm³, maximum particle size=0.6 to 1.2 mm

Fine aggregate No. 2-1: titanium slag (T) aggregate, true density=4.25 g/cm³, maximum particle size=under 0.6 mm

Fine aggregate No. 2-2: titanium slag (T) aggregate, true density=4.25 g/cm³, maximum particle size=0.6 to 1.2 mm

Fine aggregate No. 3-1: silica sand (S), true density=2.65 g/cm³, 8 to 16 mesh, maximum particle size=under 0.6 mm

Fine aggregate No. 3-2: silica sand (S), true density=2.65 g/cm³, 20 to 40 mesh, maximum particle size=0.6 mm to 1.2 mm

Fine aggregate No. 4-1: Limestone sand (L), true density=2.70 g/cm³, 8 to 16 mesh, maximum particle size=under 0.6 mm

Fine aggregate No. 4-2: Limestone sand (L), true density=2.70 g/cm³, 20 to 40 mesh, maximum particle size=0.6 mm to 1.2 mm Polymer emulsion of vinyl acetate EVA/a: Denka EVA Tex No. 59, manufactured by Denka, solid content=56%, Tg=−18° C.

Polymer emulsion of vinyl acetate EVA/b: Denka EVA Tex No. 90, manufactured by Denka, solid content=56%, Tg=0° C.

Polymer emulsion of vinyl acetate EVA/c: Sumika Flex S955-HQ, manufactured by SUMIKA CHEMTEX, solid content=53%, Tg=−30° C.

Polymer emulsion of butadiene SBR: Laticrete L-5000, manufactured by NIPPON A & L Inc., solid content=43%, Tg=−18° C., nonionic

Polymer emulsion of acrylic resin AC: PRIMAL AS-8000, manufactured by ROHMIHAAS, solid content=56%, Tg=−8° C.

Water: tap water.

Test Protocol

The following tests were carried out at 30 degrees C.

Flow: according to ASTM C230.

Segregation: A floor patching composition was prepared in a container by mixing water and the other materials and settled for 5 minutes. After that, if the fine aggregate precipitated at the bottom of the container, the sample was determined to occur segregation (“NG”). If the fine aggregate did not precipitate at the bottom, it was “Good.”

Setting time: according to EN 196-3.

Adhesive strength: according to ASTM D 4541; the material was put as 2 mm thick on a concrete plate, measured at the age of 7 days.

Durability: An existing floor concrete was chipped by 30 cm width×1 m length×10 mm depth. The floor patching compositions were filled in the chipped area, respectively. After 6 hours, the repaired areas were opened to access. After 3 months, the areas were observed by eye to determine there were any abrasion or subsidence, scalings, or cracks thereon. The areas were evaluated as following.
NG: the area had a scaling or abrasion or subsidence.
Poor: the area did not have any a scaling or abrasion or subsidence, but a crack.
Good: the area was sound.

TABLE 1

| | Amount (parts) | | | | | | | |
|---|---|---|---|---|---|---|---|---|
| | quick-setting cement | | line aggregate(s) | | | | | |
| | ratio of | | 1st | | | | | |
| | cement/rapid | | aggregate | 2nd | average | polymer emulsion | | Properities |
| | hardening | total | undef | aggregate | true | and water | | Flow |
| Nos. | agent | amount | 0.6 mm | 0.5-1.2 mm | density | solid content | water | (mm) |
| 1-1 | 80/20 | 120 | FN 440 | S 440 | 2.93 | EVA(a) 80 | 120 | 200 |
| 1-2 | 70/30 | 120 | FN 440 | S 440 | 2.93 | EVA(a) 80 | 120 | 200 |
| 1-3 | 60/40 | 120 | FN 440 | S 440 | 2.93 | EVA(a) 80 | 120 | 200 |
| 1-4 | 50/50 | 120 | FN 440 | S 440 | 2.93 | EVA(a) 80 | 120 | 200 |
| 1-5 | 70/30 | 120 | S 440 | S 440 | 2.65 | EVA(a) 80 | 120 | 155 |
| 1-6 | 70/30 | 120 | S440 | S220 + FN220 | 2.80 | EVA(a) 80 | 120 | 160 |
| 1-7 | 70/30 | 120 | S220 + FN220 | S 440 | 2.80 | EVA(a) 80 | 120 | 175 |
| 1-8 | 70/30 | 120 | FN 440 | S220 + FN220 | 3.06 | EVA(a) 80 | 120 | 190 |
| 1-9 | 70/30 | 120 | S220 + FN220 | FN 440 | 3.06 | EVA(a) 80 | 120 | 180 |
| 1-10 | 70/30 | 120 | FN 440 | FN 440 | 3.20 | EVA(a) 80 | 120 | 165 |
| 1-11 | 70/30 | 120 | T 440 | S 440 | 3.48 | EVA(a) 80 | 120 | 200 |
| 1-12 | 70/30 | 120 | T 440 | T 440 | 4.25 | EVA(a) 80 | 120 | 155 |
| 1-2 | 70/30 | 120 | FN 440 | S 440 | 2.93 | EVA(a) 80 | 120 | 195 |
| 1-13 | 70/30 | 120 | FN 440 | S 440 | 2.93 | EVA(b) 80 | 120 | 200 |
| 1-14 | 70/30 | 120 | FN 440 | S440 | 2.93 | EVA(c) 80 | 120 | 195 |
| 1-15 | 70/30 | 120 | FN 440 | S 440 | 2.93 | SBR 80 | 120 | 205 |
| 1-16 | 70/30 | 120 | FN 440 | S 440 | 2.93 | AC 80 | 120 | 195 |
| 1-17 | 70/30 | 120 | FN 440 | S 440 | 2.93 | EVA(a) 20 | 120 | 165 |
| 1-18 | 70/30 | 120 | FN 440 | S 440 | 2.93 | EVA(a) 40 | 120 | 190 |
| 1-2 | 70/30 | 120 | FN 440 | S 440 | 2.93 | EVA(a) 80 | 120 | 200 |
| 1-19 | 70/30 | 120 | FN 440 | S 440 | 2.93 | EVA(a) 120 | 120 | 180 |
| 1-20 | 70/30 | 120 | FN 440 | S 440 | 2.93 | EVA(a) 140 | 120 | 170 |
| 1-21 | 50/50 | 90 | FN 440 | S 440 | 2.93 | EVA(a) 80 | 90 | 170 |
| 1-22 | 70/30 | 150 | FN 440 | S 440 | 2.93 | EVA(a) 80 | 180 | 240 |
| 1-23 | 70/30 | 120 | S 440 | S 440 | 2.55 | AC 80 | 120 | 155 |
| 1-24 | 70/30 | 120 | S 440 | S 440 | 2.65 | AC 80 | 140 | 190 |
| 1-25 | 70/30 | 120 | L 440 | L440 | 2.70 | EVA(a) 80 | 120 | 155 |
| 1-26 | 70/30 | 120 | FN 440 | L440 | 2.95 | EVA(a) 80 | 120 | 180 |

| | Properities | | | | |
|---|---|---|---|---|---|
| | | | | early access | |
| | | | adhesive | at age 6 hrs | |
| | | Setting | strength | Durability | |
| | | time | at 7 d | at age | |
| Nos. | Segregation | (min) | (N/mm2) | 3 months | Notes |
| 1-1 | Good | 30 | 1.3 | Good | Inventive |
| 1-2 | Good | 30 | 1.5 | Good | Inventive |
| 1-3 | Good | 25 | 1.6 | Good | Inventive |
| 1-4 | Good | 20 | 1.7 | Good | Inventive |
| 1-5 | Good | 30 | 1.0 | Poor | comparative |
| 1-6 | Good | 30 | 1.2 | Good | Inventive |
| 1-7 | Good | 30 | 1.2 | Good | Inventive |
| 1-8 | Good | 30 | 1.3 | Good | Inventive |
| 1-9 | Good | 30 | 1.3 | Good | Inventive |
| 1-10 | Good | 30 | 1.2 | Good | Inventive |
| 1-11 | Good | 30 | 1.3 | Good | Inventive |
| 1-12 | NG | 30 | 1.1 | Good | comparative |
| 1-2 | Good | 30 | 1.5 | Good | Inventive |
| 1-13 | Good | 30 | 1.3 | Good | Inventive |
| 1-14 | Good | 35 | 0.7 | Poor | comparative |
| 1-15 | Good | 30 | 1.3 | Good | Inventive |
| 1-16 | Good | 30 | 1.3 | Good | Inventive |
| 1-17 | NG | 30 | 0.5 | Poor | comparative |
| 1-18 | Good | 30 | 1.0 | Poor | Inventive |
| 1-2 | Good | 30 | 1.5 | Good | Inventive |
| 1-19 | Good | 30 | 1.7 | Good | Inventive |
| 1-20 | Good | 30 | 1.7 | Good | Inventive |
| 1-21 | Good | 20 | 1.1 | Good | Inventive |
| 1-22 | Good | 30 | 1.7 | Good | Inventive |
| 1-23 | Good | 30 | 1.2 | NG | comparative |
| 1-24 | Good | 30 | 0.9 | NG | comparative |
| 1-25 | Good | 35 | 1.0 | Poor | comparative |
| 1-26 | Good | 30 | 1.4 | Good | Inventive |

Discussions

Examples 1-1 to 1-4 used both ferronickel slag and silica sand as fine aggregate and EVA emulsion having the suitable Tg. Every example had an excellent flow, and did not occur any segregation. The adhesive strength increased in proportion to the amount of the rapid hardening agent.

Example 1-5 (comparative) used only silica sand as fine aggregate. The fine aggregate had a small true density and occupied a large volume, and then the fluidity was poor. Early access at the age of 6 hours let the repaired area have cracks and scalings. It assumes that the amount of exhausted water was insufficient to make a coating from the emulsion.

Examples 1-6 to 1-11 were based on Example 1-2 except for the fine aggregate. Either one of under 0.6 mm or 0.6 mm to 1.2 mm aggregate or the both included a heavy aggregate. They occurred no segregation while they had good adhesive strength and durability.

Example 1-12 (comparative) had too heavy fine aggregate. Simply increasing the mass of fine aggregate rather induced segregation and deteriorated flow value.

Example 1-14 (comparative) and Examples 1-13, 1-15, and 1-16 were based on Example 1-2 except for the polymer emulsion. If the Tg failed to fall within the given range, the adhesive strength and the durability were poor.

Polymer emulsion other than EVA resulted in good if the Tg was in the given range.

Example 1-17 (comparative) and Examples 1-18 to 1-20 were based on Example 1-2 except for the amount of the polymer emulsion. The larger the amount of polymer emulsion, the higher the adhesive strength and durability, but reached a plateau with decreasing the flow value.

Examples 1-21 and 1-22 aimed to evaluate an effect of the amount of the quick-setting cement. Depending on the amount of water, they had good fluidity, adhesion, and durability.

Examples 1-23 and 1-24 (comparative) used silica sand only as the fine aggregate and AC as the polymer emulsion. They were worse than Example 1-5. In particular, Example 1-23 used a lot of water to increase the flow, but it severely deteriorated the adhesive strength.

Example 1-25 (comparative) and Example 1-26 included lime sand in the fine aggregate. Example 1-25 failed to meet the given average true density and was poor in adhesive strength and durability. In contrast, Example 1-26 had an excellent result.

1. A floor patching composition, comprising:
100 parts of a dry mortar composition including:
9 to 15 parts of quick-setting cement, and
85 to 94 parts of a sole fine aggregate or a combination of two or more fine aggregates, wherein the sole fine aggregate or the combination has an average true density of 2.8 to 4.0 g/cm³ and a maximum particle size of 1.2 mm or less;
3 to 18 parts of polymer emulsion solid content having a glass transition temperature (Tg) of equal to or higher than −20° C. and equal to or less than 10° C.; and
6 to 18 parts of water.

2. The composition according to claim 1, wherein the quick-setting cement comprises:
50 to 80 parts of cement; and
20 to 50 parts of a rapid hardening agent,
wherein the rapid hardening agent comprises an amorphous calcium aluminosilicate compound in which a glass content is 50% or more, and gypsum.

3. The composition according to claim 1, wherein the fine aggregate comprises at least a first fine aggregate and a second fine aggregate,
wherein the second fine aggregate has a maximum particle size larger than that of the first fine aggregate, and
wherein the first fine aggregate has an average true density different than that of the second fine aggregate.

4. The composition according to claim 3,
wherein the maximum particle size of the first fine aggregate is less than 0.6 mm, and
wherein the maximum particle size of the second fine aggregate is equal to or greater than 0.6 mm.

5. A method for patching a floor, the method comprising the steps of:
preparing the composition according to claim 1; and
applying the composition onto a floor.
